(19) United States
(12) Patent Application Publication
(10) Pub. No.: US 2008/0138189 A1
(43) Pub. Date: Jun. 12, 2008

(54) FUEL PUMP AND FUEL FEED APPARATUS HAVING THE SAME

(75) Inventors: Tadashi HAZAMA, Chita-gun (JP); Eiji Iwanari, Chiryu-city (JP); Kenichi Tomomatsu, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/946,094

(22) Filed: Nov. 28, 2007

(30) Foreign Application Priority Data
Dec. 6, 2006 (JP) 2006-329041
Sep. 28, 2007 (JP) 2007-252941

(51) Int. Cl. F02M 37/04; F04D 5/00

(52) U.S. Cl. 415/55.1; 417/423.1

(57) ABSTRACT

A fuel pump includes an impeller having first and second vane grooves each arranged along a rotative direction. The second vane grooves are located on a radially inner side of the first vane grooves. The fuel pump includes a pump case rotatably accommodating the impeller and having first and second pump passages. The first pump passage is defined along the first vane grooves for supplying fuel from a sub-tank to an engine. The second pump passage is defined along the second vane grooves for supplying fuel from the fuel tank to the sub-tank. The first and second pump passages respectively have cross sectional areas S1, S2, and respectively have diameters D1, D2 with respect to a direction of a rotation axis of the impeller. The S1, D1, S2, and D2 satisfy: 0.6≦(S2×D2)/(S1×D1)≦0.95.

### CROSS REFERENCE TO RELATED APPLICATIONS

This application is based on and incorporates herein by reference Japanese Patent Applications No. 2006-329041 filed on Dec. 6, 2006 and No. 2007-252941 filed on Sep. 28, 2007.

### FIELD OF THE INVENTION

The present invention relates to a fuel pump including an impeller having two lines of vane grooves located radially different positions from each other. The present invention further relates to a fuel feed apparatus having the fuel pump for supplying fuel from a sub-tank to an engine simultaneously with supplying fuel from the fuel tank to the sub-tank.

### BACKGROUND OF THE INVENTION

As generally known, a fuel pump is provided in a sub-tank, which is accommodated in a fuel tank, for pumping fuel from the sub-tank to an internal combustion engine. For example, U.S. Pat. No. 5,596,970 and U.S. Pat. No. 6,179,579 (JP-A-2002-500718) disclose such fuel pumps each including a fuel pump supplying fuel from a fuel tank to a sub-tank without using a jet pump.

In each of U.S. Pat. No. 5,596,970 and U.S. Pat. No. 6,179,579, a fuel pump includes an impeller, which has two lines of vane grooves located radially different positions from each other, and a pump case, which rotatably accommodates the impeller and have pump passages along the two lines of vane grooves. The impeller rotates and draws fuel from the sub-tank to supply the fuel to the engine through the pump passages extending along the vane grooves on the radially outer side. The impeller also draws fuel from the fuel tank to supply the fuel to the sub-tank through the pump passages extending along the vane grooves on the radially inner side.

The fuel pump supplies an amount Q1 of fuel to the engine and an amount Q2 of fuel to the sub-tank. In such a fuel pump, the values of Q1 and Q2 need to satisfy a relationship of Q2≧Q1, even when the engine requires a maximum amount in a condition where the engine produces a maximum power. When the amount Q2 of fuel supplied from the fuel tank to the sub-tank is less than the amount Q1 of fuel supplied from the sub-tank to the engine (Q2≦Q1), the level of the sub-tank decreases, and consequently, the fuel pump cannot draw fuel from the sub-tank. Therefore, the fuel pump needs to be designed to have the two lines of vane grooves and pump passages adapted to satisfying the relationship of Q2≧Q1 and restricting the level of the sub-tank from decreasing.

Pressure of fuel pumped from the sub-tank to the engine is significantly greater than pressure of fuel pumped from the fuel tank to the sub-tank. Therefore, pressure difference in the pump passage for pumping fuel from the sub-tank to the engine is greater than pressure difference in the pump passage for pumping fuel from the fuel tank to the sub-tank, with respect to a rotative direction of the impeller. When the pressure difference in the pump passages becomes large, fuel is applied with force in the opposite direction to the rotative direction, and consequently, a pump efficiency of the fuel pump decreases. In addition, when fuel is pressurized to be in high pressure, an amount of fuel leaking through a clearance between the pump case and the impeller becomes large, and consequently, the pump efficiency decreases. Thus, the fuel pump needs to be designed in consideration of fuel pressure increased through the pump passages, in addition to the amount of fuel supplied from the fuel pump. Here, the pump efficiency η is defined by: η=(P×Q)/(T×R). Here, T is a torque produced by the motor portion of the fuel pump, R is rotation speed of the motor portion, P is discharge pressure of fuel after passing through the pump passages, and Q is an amount of the fuel discharged after passing through the pump passages.

Neither U.S. Pat. No. 5,596,970 nor U.S. Pat. No. 6,179,579 describes a fuel pump adapted to restricting the level of the sub-tank from decreasing, in consideration of pressure of fuel in the pump passages.

### SUMMARY OF THE INVENTION

In view of the foregoing and other problems, it is an object of the present invention to produce a fuel pump including an impeller having two lines of vane grooves and adapted to controlling an amount of fuel supplied from a fuel tank to the sub-tank, in consideration of pressure of fuel in the pump passages. It is another object of the present invention to produce a fuel feed apparatus having the fuel pump for supplying fuel from the sub-tank to an engine simultaneously with supplying fuel from the fuel tank to the sub-tank.

According to one aspect of the present invention, a fuel pump for supplying fuel from a fuel tank to a sub-tank accommodated in the fuel tank and supplying fuel from the sub-tank to an engine, the fuel pump comprising an impeller having a plurality of first vane grooves and a plurality of second vane grooves each arranged along a rotative direction of the impeller. The plurality of second vane grooves is located on a radially inner side of the plurality of first vane grooves with respect to a radial direction of the impeller. The fuel pump further comprising a pump case rotatably accommodating the impeller and having a first pump passage and a second pump passage each being defined along the rotative direction. The first pump passage is defined along the first vane grooves for supplying fuel from the sub-tank to the engine. The second pump passage is defined along the second vane grooves for supplying fuel from the fuel tank to the sub-tank. The first and second pump passages respectively have cross sectional areas S1, S2. The first and second pump passages respectively have diameters D1, D2 with respect to a direction of a rotation axis of the impeller. The cross sectional areas S1, S2 and the diameters D1, D2 satisfy: 0.6≦(S2×D2)/(S1×D1)≦0.95.

According to another aspect of the present invention, a fuel feed apparatus for supplying fuel from a fuel tank to an engine, the fuel feed apparatus comprising a sub-tank accommodated in the fuel tank. The fuel feed apparatus further comprising a fuel pump accommodated in the sub-tank for supplying fuel from the fuel tank to the sub-tank simultaneously with supplying fuel from the sub-tank to an engine. The fuel pump includes an impeller having a plurality of first vane grooves and a plurality of second vane grooves each arranged along a rotative direction of the impeller, the plurality of second vane grooves being located on a radially inner side of the plurality of first vane grooves. The fuel pump further includes a pump case rotatably accommodating the impeller and having first and second pump passages each being defined along the rotative direction. The first pump passage extends along the first vane grooves. The first pump passage communicates with an inlet, which is located inside of the sub-tank for drawing fuel, and communicates with an outlet for supplying fuel to the engine. The second pump passage extends along the second vane grooves. The second pump passage communicates with an inlet, which is located outside of the sub-tank and opening in the fuel tank for drawing fuel from the fuel tank, and communicates with an outlet opening in the sub-tank for supplying fuel to the sub-tank. The first and second pump passages respectively have cross sectional areas S1, S2. The first and second pump passages respectively have diameters D1, D2 with respect to a direction of a rotation axis of the impeller. The cross sectional areas S1, S2 and the diameters D1, D2 satisfy: 0.6≦(S2×D2)/(S1×D1)≦0.95.

### BRIEF DESCRIPTION OF THE DRAWINGS

The above and other objects, features and advantages of the present invention will become more apparent from the following detailed description made with reference to the accompanying drawings. In the drawings:

FIG. 1 is a sectional view showing pump passages of a fuel pump according to a first embodiment;

FIG. 2 is a sectional view showing a fuel feed apparatus according to the first embodiment;

FIG. 3 is a graph showing a relationship between a value of Q2/Q1 and a value of (S2×D2)/(S1×D1);

FIG. 4 is a graph showing a relationship between a value of H/t and a pump efficiency η;

FIG. 5 is a graph showing a relationship between a value of W/H and a pump efficiency η;

FIG. 6 is a sectional view showing pump passages of a fuel pump according to a second embodiment;

FIG. 7 is a sectional view showing a fuel feed apparatus according to the second embodiment;

FIG. 8 is a top view showing an impeller;

FIG. 9 is a graph showing a relationship among a seal width a1, a pump efficiency η, and a value of Q2/Q1; and

FIG. 10 is a graph showing a relationship among a thickness ratio B2/B1, a swelling speed ratio V2/V1, and the value of Q2/Q1.

### DETAILED DESCRIPTION OF PREFERRED EMBODIMENTS

### First Embodiment

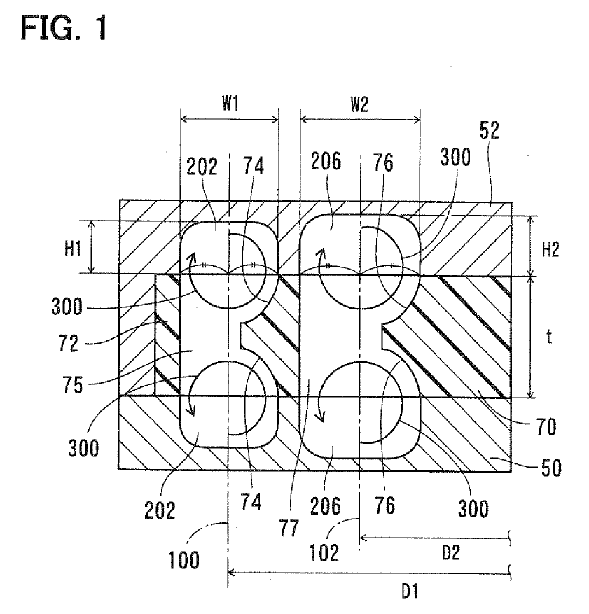

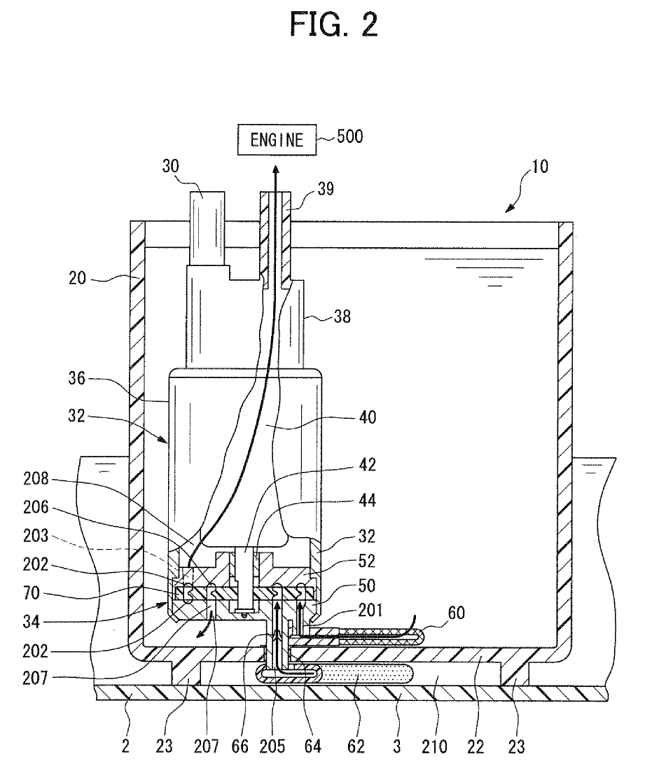

The first embodiment is described with reference to FIGS. 1 to 5. FIG. 2 depicts a fuel pump according to the first embodiment. In FIG. 2, a bold arrow depicts a flow direction of fuel. A fuel feed apparatus 10 is accommodated in a fuel tank 2 in a condition where a sub-tank 20 of the fuel feed apparatus 10 receives a fuel pump 30. The fuel pump 30 is an in-tank type pump that is provided in an interior of a fuel tank of a vehicle such as a two-wheel automobile and a four-wheel automobile.

The sub-tank 20 is formed of resin to be substantially in a bottomed cylindrical shape or a rectangular box shape, for example. The sub-tank 20 has a bottom wall 22 provided with feet 23 each protruding toward a bottom wall 3 of the fuel tank 2. The feet 23 are in contact with the bottom wall 3 of the fuel tank 2. The bottom wall 22 of the sub-tank 20 and the bottom wall 3 of the fuel tank 2 therebetween define a space 210 by providing the feet 23.

The fuel pump 30 includes a motor portion 32 and a pump portion 34. The motor portion 32 drives the pump portion 34. A housing 36 accommodates both the motor portion 32 and the pump portion 34. The housing 36 has both axial ends respectively crimped and fixed to an end cover 38 and a pump case 50. The end cover 38 is formed of resin. The end cover 38 has a discharge port 39 through which the fuel pump 30 pumps fuel to an internal combustion engine 500.

The motor portion 32 is a DC motor having permanent magnets, a commutator, brushes, a choke coil, an armature 40, and the like. Each of the permanent magnets is in a substantially arch shape. The permanent magnets are circumferentially arranged along the inner circumferential periphery of the housing 36.

The armature 40 is rotatable on the radially inner side of the permanent magnets. The armature 40 has a shaft 42 rotatably supported by metallic bearings 44 at both axial ends. FIG. 2 depicts one of the metallic bearings 44 at one axial end of the shaft 42. The bearing 44 is supported by a pump case 52. The armature 40 includes a rotor core and coils. The rotor core has multiple magnetic cores arranged along a rotative direction thereof. The coils are respectively wound around the magnetic cores. The coils of the armature 40 are supplied with a driving current via the brushes and the commutator.

The pump portion 34 is a turbine pump that includes pump cases 50, 52, and an impeller 70. The pump portion 34 is provided to one axial end of the armature 40 of the motor portion 32. Each of the pump cases 50, 52 is a case member formed of a metallic material such as aluminum or resin excellent in resistance to fuel and excellent in mechanical strength. The pump cases 50, 52 rotatably accommodate the impeller 70. The pump case 50 covers the pump portion 34 on the side of the sub-tank 20. The pump case 52 covers the pump portion 34 on the side of the armature 40.

The impeller 70 is formed of resin, which is excellent in resistance to fuel and excellent in mechanical strength, to be substantially in a disc-shape.

As shown in FIG. 1, the impeller 70 has an annular portion 72 defining the outer circumferential periphery thereof. The impeller 70 has multiple vane grooves 74 on the radially inner side of the annular portion 72. The vane grooves 74 are arranged with respect to the rotative direction. The vane grooves 74 serve as first vane grooves 74. The impeller 70 has multiple vane grooves 76 on the radially inner side of the vane grooves 74. The vane grooves 76 are arranged with respect to the rotative direction. The vane grooves 76 are located at positions different from positions of the vane grooves 74 with respect to the radial direction of the impeller 70. The vane grooves 76 serve as second vane grooves 76.

The vane grooves 74, 76 are provided to both the axial sides of the impeller 70. The vane grooves 74, 76, which are provided to both the axial sides of the impeller 70, communicate with each other. Fuel flows into the vane grooves 74, 76, and the fuel forms a swirl flow 300 in both the vane grooves 74, 76 on both the axial sides. The vane grooves 74, 76, which are adjacent to each other with respect to the rotative direction, are partitioned respectively with partition walls 75, 77.

The pump cases 50, 52 on both axial sides of the impeller 70 respectively define first and second pump passages 202, 206 substantially in C shapes along the vane grooves 74, 76 in the rotative direction of the impeller 70. The first pump passage 202 serves as a first pump passage communicating with the vane grooves 74. The second pump passage 206 serves as a second pump passage communicating with the vane grooves 76.

Referring to FIG. 2, the pump case 50 has a fuel inlet 201 of the first pump passage 202. The pump case 52 has a fuel outlet 203 of the first pump passage 202. The fuel inlet 201 opens to the inside of the sub-tank 20. The fuel outlet 203 of the first pump passage 202 opens to a fuel chamber 208 in the motor portion 32. The fuel inlet 201 is provided with a suction filter for removing foreign matters contained in fuel flowing from the sub-tank 20.

The pump case 50 has a fuel inlet 205 and a fuel outlet 207 of the second pump passage 206. The fuel inlet 205 is a through hole extending through the bottom wall 22 of the sub-tank 20. The fuel inlet 205 opens to both the outside of the sub-tank 20 and the inside of the fuel tank 2. The fuel outlet 207 opens to the inside of the sub-tank 20. The bottom wall 22 of the sub-tank 20 has a bottom inner periphery defining a through hole, through which the fuel inlet 205 extends. This bottom inner periphery of the bottom wall 22 and the fuel inlet 205 therebetween interpose an elastic member 64 formed of an elastic material to be substantially in a cylindrical shape. The elastic member 64 serves as a seal member. The elastic member 64 restricts fuel from leaking from the through hole of the bottom wall 22. The fuel inlet 205 is provided with a check valve 66 for restricting fuel from reverse-flowing from the sub-tank 20 into the fuel tank 2. The check valve 66 is provided to the fuel inlet 205, and hence, a reverse-flow of fuel is restricted from the fuel pump 30 into the fuel tank 2. Thus, the fuel pump 30 is capable of accumulating fuel in a condition where the fuel pump 30 stops. Consequently, the fuel pump 30 is capable of quickly drawing fuel through the fuel inlet 205 to supply the fuel from the fuel tank 2 into the sub-tank 20 in a condition where the fuel pump 30 starts an operation thereof. The fuel inlet 205 is provided with a suction filter 62 for removing foreign matters contained in fuel flowing from the fuel tank 2. The suction filter 62 is provided in the space 210 defined among the bottom wall 22 of the sub-tank 20 and the bottom wall 3 of the fuel tank 2.

Referring to FIG. 2, the armature 40 operates, and the impeller 70 rotates together with the shaft 42 to draw fuel into the first and second pump passages 202, 206 through the fuel inlets 201, 205. The fuel inflows and outflows between the vane grooves 74, 76 on the forward side and the vane grooves 74, 76 on the backward side with respect to the rotative direction. The fuel repeats the inflow and outflow to form the swirl flow 300 being pressurized through the first and second pump passages 202, 206.

The impeller 70 rotates to draw fuel from the sub-tank 20 through the fuel inlet 201, and the fuel is pressurized through the first pump passage 202 on both sides with respect to the rotation axis. The fuel merges in the fuel outlet 203 of the pump case 52 on the side of the motor portion 32. Thus, the fuel is discharged into the fuel chamber 208 of the motor portion 32 through the fuel outlet 203. The fuel discharged into the fuel chamber 208 through the fuel outlet 203 passes through a clearance between the outer circumferential periphery of the armature 40 and the inner circumferential peripheries of the permanent magnets. Thus, the fuel is supplied to the engine 500 through the discharge port 39 of the end cover 38. In this operation, fuel pressurized in the pump portion 34 flows through the interior of the motor portion 32, and hence, the fuel cools the motor portion 32, and lubricates sliding portions inside of the motor portion 32.

The amount of fuel discharged to the engine 500 through the discharge port 39 is about 20 L/h to 300 L/h. This amount of fuel discharged through the discharge port 39 is equivalent to an amount of fuel discharged through the fuel outlet 203 of the first pump passage 202. The rotation speed of the impeller 70 is about 4000 to 15000 rpm.

The impeller 70 rotates to draw fuel from the fuel tank 2 through the fuel inlet 205, and the fuel is pressurized through the second pump passage 206 on both sides with respect to the rotation axis. The fuel merges in the fuel outlet 207 of the pump case 50, and is discharged into the sub-tank 20 through the fuel outlet 207.

Here, the amount of fuel supplied from the first pump passage 202 is Q1. The diameter of the first pump passage 202 with respect to the rotation axis of the impeller 70 is D1. The cross sectional area of the first pump passage 202 is S1. The amount of fuel supplied from the second pump passage 206, which is located on the radially inner side of the first pump passage 202, is Q2. The diameter of the second pump passage 206 with respect to the rotation axis of the impeller 70 is D2. The cross sectional area of the second pump passage 206 is S2. The rotation speed of the impeller per one minute is R rpm. The values of Q1, Q2 are defined by the following formulas (1), (2). In the present structure, the first and second pump passages 202, 206 are provided on both sides of the impeller 70 with respect to the rotation axis, and the values of S1, S2 are summation of the cross sectional areas of the first and second pump passages 202, 206 on both sides of the impeller 70.

Q1=π×S1×D1×R (1)

Q2=π×S2×D2×R (2)

Therefore, when fuel is supplied from the sub-tank 20 to the engine 500, Q2≧Q1 suffices to maintain the level of the sub-tank 20 in consideration of the amount of fuel passing through the first and second pump passages 202, 206 and without consideration of pressure of fuel in the first and second pump passages 202, 206. That is, the following formula (3) suffices to maintain the level of the sub-tank 20.

Q2≧Q1

π×S2×D2×R≧π×S1×D1×R

(S2×D2)/(S1×D1)≧1 (3)

However, pressure in the first pump passage 202 where fuel supplied from the sub-tank 20 to the engine 500 is pressurized is higher than pressure in the second pump passage 206 where fuel supplied from the fuel tank 2 to the sub-tank 20 is pressurized. Therefore, decrease in the discharge amount Q1 in the first pump passage 202 defined by the formula (1) is greater than decrease in the discharge amount Q2 in the second pump passage 206 defined by the formula (2). Accordingly, when the cross sectional areas S1, S2 and the diameters D1, D2 are determined simply to satisfy the formula (3), an actual value of the discharge amount Q2 becomes excessively greater than an actual value of the discharge amount Q1. As a result, fuel is excessively supplied from the fuel tank 2 to the sub-tank 20.

As follows, design values of the impeller 70, and the first and second pump passages 202, 206 are described.

The impeller 70 has the outer diameter in a range between 20 mm and 50 mm. The first and second pump passages 202, 206 are defined along the vane grooves 74, 76 on both sides with respect to the rotation axis. The first pump passage 202 on one side with respect to the rotation axis has a cross sectional area S1. The second pump passage 206 on one side with respect to the rotation axis has a cross sectional area S2. Each cross sectional area S1, S2 is defined in a range between 2 square millimeter and 8 square millimeter. The discharge amount of fuel through the first pump passage 202 is Q1, the diameter of the first pump passage 202 with respect to the rotation axis of the impeller 70 is D1, the discharge amount of fuel through the second pump passage 206 is Q2, the diameter of the second pump passage 206 with respect to the rotation axis of the impeller 70 is D2, and the rotation speed of the impeller 70 is R per minute. The values of the discharge amount Q1, Q2 are defined by the above formulas (1), (2). In the formulas (1), (2), the S1 is substituted to 2×S1, and the S2 is substituted to 2×S2. The diameter D1 is the distance between a center 100 of a width W1 of the first pump passage 202 and the center 100 of the width W1 with respect to the radial direction of the impeller 70. The diameter D2 is the distance between a center 102 of the width W2 of the second pump passage 206 and the center 102 of the width W2 with respect to the radial direction of the impeller 70.

Here, Q2≧Q1 suffices to maintain the level of the sub-tank 20 even supplying fuel from the sub-tank 20 to the engine 500 outside of the fuel tank 2. That is, the formula (3) suffices to restrict decrease in the level of the sub-tank 20.

Pressure of fuel pressurized through the first pump passage 202 is higher than pressure of fuel pressurized through the second pump passage 206. Fuel is pressurized through the first pump passage 202 to be in fuel pressure P1, and supplied from the fuel pump 30 to the engine 500. Fuel is also pressurized through the second pump passage 206 to be in fuel pressure P2, and supplied from the fuel pump 30 to the sub-tank 20. For example, the fuel pressure P1 is required to be in the range between 200 kPa and 800 kPa. By contrast, the fuel pressure P2 is required to be 50 kPa, at maximum. Consequently, pressure difference arises in each of the first and second pump passages 202, 206 relative to the rotative direction, and causes force applied to fuel in each of the first and second pump passages 202, 206 oppositely to the rotative direction. The force oppositely applied to fuel in the first pump passage 202 is greater than the force oppositely applied to fuel in the second pump passage 206. The pressure difference further causes leakage of fuel in the first and second pump passages 202, 206 through each of the clearances between the pump cases 50, 52 and the impeller 70. The leakage of fuel from the first pump passage 202 is greater than the leakage of fuel from the second pump passage 206. Therefore, decrease in the discharge amount Q1 in the first pump passage 202 defined by the formula (1) is greater than decrease in the discharge amount Q2 in the second pump passage 206 defined by the formula (2). When the cross sectional areas S1, S2 and the diameters D1, D2 are determined simply to satisfy the formula (3), an actual value of the discharge amount Q2 becomes excessively greater than an actual value of the discharge amount Q1. Consequently, the discharge amount Q2, by which fuel is supplied from the fuel tank 2 to the sub-tank 20, becomes excessively large. It suffices that the sub-tank 20 is supplied with fuel such that the level of the sub-tank 20 is maintained. That is, fuel need not be excessively supplied from the fuel tank 2 to the sub-tank 20.

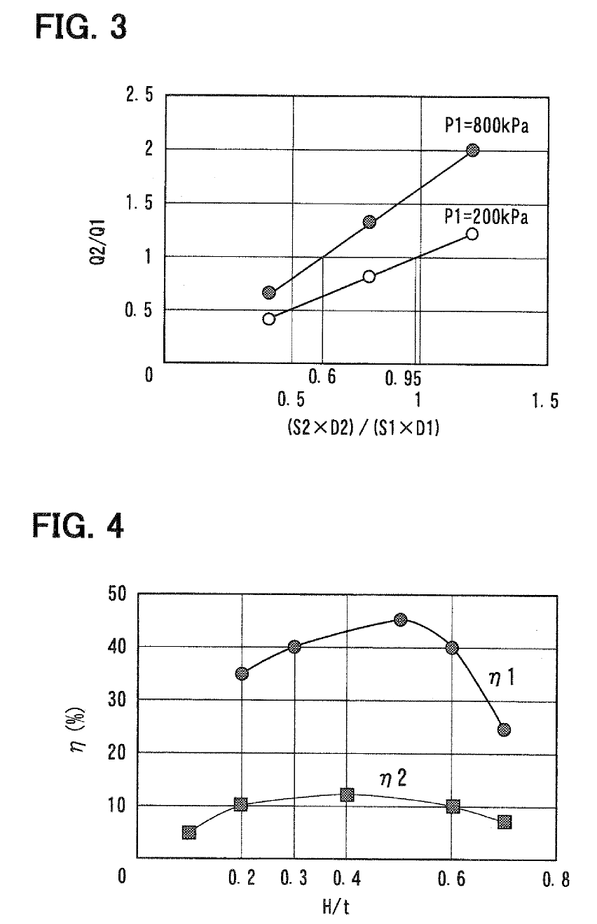

Accordingly, the range of (S2×D2)/(S1×D1) need to be determined in consideration of a range of fuel pressure P1, to which fuel is pressurized through the first pump passage 202. Fuel, which is pressurized through the first pump passage 202 and supplied from the fuel pump 30 to the engine 500, is in the fuel pressure P1 between 200 kPa and 800 kPa, for example. Therefore, the range of (S2×D2)/(S1×D1) need to be determined such that the fuel pressure P1 becomes in the range between, for example, 200 kPa and 800 kPa and the actual value of Q2/Q1 becomes possibly 1. The following formula (4) is obtained from FIG. 3,

0.6≦(S2×D2)/(S1×D1)≦0.95 (4)

The range of (S2×D2)/(S1×D1) can be determined in the range defined by the formula (4) such that the fuel pressure P1 is between 200 kPa and 800 kPa and the actual value of Q2/Q1 is possibly 1.

Further, the swirl flow 300, which passes along the first pump passage 202 and the vane grooves 74, is preferably in a circular shape. In addition, the swirl flow 300, which passes along the second pump passage 206 and the vane grooves 76, is also preferably in a circular shape. When the swirl flow 300 is substantially in a circular shape, a pump efficiency η of the swirl flow 300 can be enhanced by possibly reducing loss in kinetic energy caused by drastically changing in the flow direction of the swirl flow 300.

The first and second pump passages 202, 206 respectively have the depths H1, H2 along the rotation axis of the impeller 70. It suffices that the depths H1, H2 of the first and second pump passages 202, 206 are substantially equal respectively to the depths of the vane grooves 74, 76 with respect to the thickness direction of the impeller 70 so as to form the swirl flows 300 each being substantially in a circular shape. Each of the depths H1, H2 of the first and second pump passages 202, 206 is substantially ½ of the thickness t of the impeller 70. Accordingly, the formulas (5), (6) suffice to form the swirl flows 300 each being substantially in a circular shape.

H1/t=0.5 (5)

H2/t=0.5 (6)

Actually, when each value of H1/t and H2/t is in a predetermined range including 0.5, each swirl flow 300 may not be not excessively flat. The following formulas (7), (8) can be obtained from FIG. 4 to define ranges of H1/t and H2/t respectively satisfying η1≧40% and η2≧10%. The ranges defined by the formulas (7), (8) respectively include maximum values of pump efficiencies η1, η2 in the first and second pump passages 202, 206.

0.3≦H1/t≦0.6 (7)

0.2≦H2/t≦0.6 (8)

The pump efficiency in the second pump passage 206 is less than that in the first pump passage 202, and hence it is preferable to satisfy the formula (8) in particular.

It suffices to form the swirl flows 300 substantially in circular shapes that twice of the values of the depths H1, H2 of the pump passages are substantially equal respectively to the widths W1, W2 of the first and second pump passages 202, 206 with respect to the radial direction of the impeller 70. That is, the formulas (9), (10) suffice to form the swirl flows 300 substantially in circular shapes.

2=W1/H1 (9)

2=W2/H2 (10)

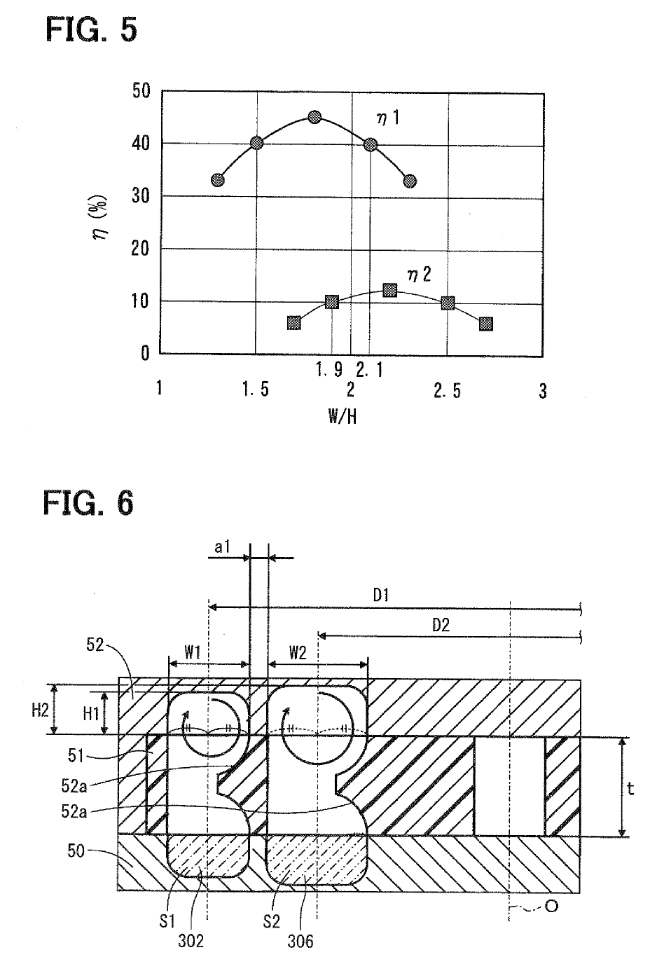

Actually, when each value of W1/H1 and W2/H2 is in a predetermined range including 2, the flow direction of each swirl flow 300 is not excessively flat. The following formulas (11), (12) can be obtained from FIG. 5 to define ranges of W1/H1 and W2/H2 respectively satisfying η1≧40% and η2≧10%. The ranges defined by the formulas (11), (12) respectively include maximum values of pump efficiencies η1, η2 in the first and second pump passages 202, 206.

1.5≦W1/H1≦2.1 (11)

1.9≦W2/H2≦2.5 (12)

The pump efficiency η2 in the second pump passage 206 is less than the pump efficiency η1 in the second pump passage 206, and hence it is preferable to satisfy the formula (12) in particular.

In this embodiment, the fuel pump 30 has the vane grooves 74, 76, which are different from each other in the positions with respect to the radial direction of the impeller 70. The fuel pump 30 supplies fuel from the sub-tank 20 to the engine 500, as well as supplying fuel from the fuel tank 2 to the sub-tank 20. In the fuel pump 30, the first and second pump passages 202, 206 respectively have the cross sectional areas S1, S2, and the first and second pump passages 202, 206 respectively have the diameters D1, D2 with respect to the axial direction of the impeller 70. Further, in particular, the range of (S2×D2)/(S1×D1) is determined to satisfy the formula (3) in consideration of pressure in the first pump passage 202 where fuel supplied to the engine 500 is pressurized. Thus, the fuel level of the sub-tank 20 can be restricted from decreasing, and the amount of fuel supplied from the fuel tank 2 to the sub-tank 20 can be restricted from excessively increasing.

Furthermore, the depths H1, H2 of the first and second pump passages 202, 206 and the thickness t of the impeller 70 are properly defined such that the H1/t and the H2/t are in the range defined by the formulas (7), (8). The depths H1, H2 of the first and second pump passages 202, 206 and the widths W1, W2 of the first and second pump passages 202, 206 with respect to the radial direction are properly defined such that the W1/H1 and the W2/H2 are in the range defined by the formulas (11), (12). Consequently, the swirl flow 300 formed between the first pump passage 202 and the vane grooves 74 can be restricted from being flat in the shape. In addition, the swirl flow 300 formed between the second pump passage 206 and the vane grooves 76 can be also restricted from being flat in the shape. Thus, the pump efficiency is enhanced.

In the above embodiment, the cross sectional areas S1, S2 and the diameters D1, D2 of the first and second pump passages 202, 206 are defined to satisfy the formula (4), in consideration of pressure of fuel in the first and second pump passages 202, 206.

0.6≦(S2×D2)/(S1×D1)≦0.95 (4)

Thus, the amount Q2 of fuel supplied from the fuel tank 2 to the sub-tank 20 can be restricted from becoming excessively less than the amount of fuel Q1 supplied from the sub-tank 20 to the engine 500, by satisfying the formula of 0.6≦(S2×D2)/(S1×D1). Further, the amount Q2 of fuel supplied from the fuel tank 2 to the sub-tank 20 can be restricted from becoming excessively greater than the amount of fuel Q1 supplied from the sub-tank 20 to the engine 500, by satisfying the formula of (S2×D2)/(S1×D1)≦0.95. Thus, the amount of fuel supplied from the fuel tank 2 to the sub-tank 20 is restricted from becoming excessively large and the level of the sub-tank 20 is restricted from decreasing by determining the cross sectional areas S1, S2 and the diameters D1, D2 of the first and second pump passages 202, 206 to satisfy the formula (4).

The pressure of fuel supplied from the first pump passage is P (kPa), which satisfies: 200≦P≦800. The amount of fuel supplied from the fuel tank 2 to the sub-tank 20 is restricted from becoming excessively large and the level of the sub-tank 20 is restricted from decreasing by determining the cross sectional areas S1, S2 and the diameters D1, D2 of the first and second pump passages 202, 206 to satisfy the formula (4) with the pressure of fuel in the range of 200≦P≦800.

Fuel in the first and second pump passages 202, 206 repeats flowing out of one of the vane grooves 74, 76 on the forward side and flowing into the other of the vane grooves 74, 76 on the backward side with respect to the rotative direction with rotation of the impeller 70, and hence, the fuel forms the swirl flow 300 as being pressurized. The swirl flow 300 is preferably in a circular shape in the cross section in each passage including the first and second pump passages 202, 206 and the vane grooves 74, 76. The swirl flow 300 is substantially in a circular shape in the cross section, so that the swirl flow 300 can be restricted from drastically changing in the flow direction, and the swirl flow 300 can maintain the kinetic energy. Thus, the pump efficiency η1, η2 in the first and second pump passages 202, 206 can be enhanced. It suffices that each of the depths H1, H2 of the first and second pump passages 202, 206 is substantially equal to the depth of each of the vane groove 74, 76 with respect to the thickness direction of the impeller 70 to form the swirl flow 300 substantially in a circular shape. As defined by the formulas (5), (6), each depth H1, H2 of each of the first and second pump passages 202, 206 is substantially ½ of the thickness t of the impeller 70. Actually, when H/t is in a predetermined range including 0.5, the swirl flow 300 is not excessively flat.

H1=t/2

H2=t/2

H1/t=0.5 (5)

H2/t=0.5 (6)

The second pump passage 206 has the depth H2 with respect to the rotation axis, the impeller 70 has the thickness t, and the H2 and t satisfy: 0.2≦H2/t≦0.6. Thus, the swirl flow 300 is restricted from being excessively flat in the second pump passage 206. In this structure, energy of the swirl flow 300 in the second pump passage 206 can be maintained, and the pump efficiency η2 in the second pump passage 206 can be enhanced. Pressure of fuel after passing through the second pump passage 206 is less than pressure of fuel after passing through the first pump passage 202. Therefore, it is preferable to enhance the pump efficiency η by satisfying 0.2≦H2/t≦0.6.

The first pump passage 202 has the depth H1 with respect to the direction of the rotation axis of the impeller 70. The impeller 70 has the thickness t. The H1 and t satisfy: 0.3≦H1/t≦0.6, and hence, the swirl flow 300 in the first pump passage 202 is restricted from being excessively flat. In this structure, energy of the swirl flow 300 in the first pump passage 202 can be maintained, and the pump efficiency η in the first pump passage 202 can be enhanced.

It suffices to form the swirl flow 300 substantially in a circular shape that twice of the value of each depth H1, H2 of each pump passage 202, 206 is substantially equal to each width W1, W2 of each pump passage 202, 206 with respect to the radial direction of the impeller 70. That is, the formulas (9), (10) suffice to form the swirl flow 300 substantially in a circular shape. Actually, when W/H is in a predetermined range including 2, the swirl flow 300 is not excessively flat.

2×H1=W1

2×H2=W2

2=W1/H1 (9)

2=W2/H2 (10)

The second pump passage 206 has the width W2 with respect to the radial direction of the impeller 70, the second pump passage 206 has the depth H2 with respect to the rotation axis, and the W2 and H2 satisfy: 1.9≦W2/H2≦2.5. Thus, the swirl flow 300 is restricted from being excessively flat. In this structure, energy of the swirl flow 300 in the second pump passage can be maintained, and the pump efficiency η in the second pump passage can be enhanced. Pressure of fuel pressurized through the second pump passage 206 is less than pressure of fuel pressurized through the first pump passage 202. Therefore, it is preferable to enhance the pump efficiency η by satisfying the relationship of 1.9≦W2/H2≦2.5.

The first pump passage 202 has the width W1 with respect to the radial direction of the impeller 70, the first pump passage 202 has the depth H1 with respect to the rotation axis, and the W1 and H1 satisfy: 1.5≦W1/H1≦2.1. Thus, the swirl flow 300 is restricted from being excessively flat. In this structure, energy of the swirl flow 300 in the first pump passage 202 can be maintained, and the pump efficiency η in the first pump passage 202 can be enhanced.

### Second Embodiment

FIGS. 6 to 8 depict a fuel feed apparatus having a fuel pump according to the second embodiment. In this embodiment, referring to FIG. 6, a first pump passage 302 has the first cross sectional area S1, which is the shaded portion with the chain lines, and a second pump passage 306 has the second cross sectional area S2, which is the shaded portion with the chain double-dotted lines. The first cross sectional area S1 and the second cross sectional area S2 therebetween define a seal portion having a seal width a1. The impeller 51 has the rotation axis O.

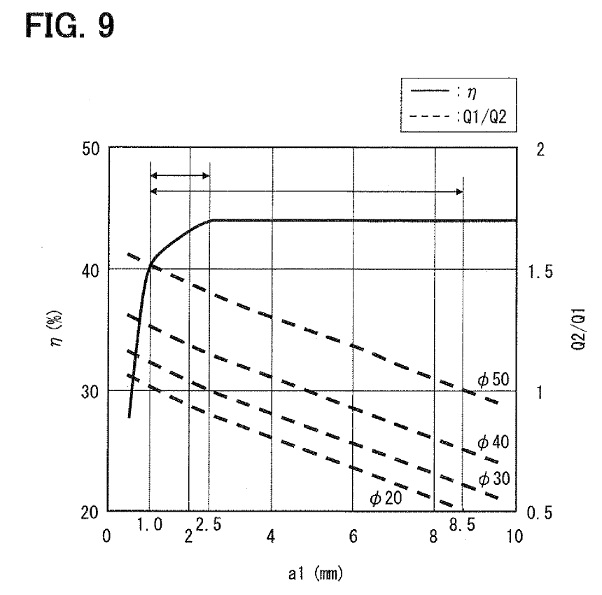

The pump efficiency η is defined by: η=(P×Q)/(T×R). Here, T is a torque produced by the motor portion of the fuel pump, R is rotation speed of the motor portion, P is discharge pressure of fuel after passing through the pump passages, and Q is an amount of the fuel discharged after passing through the pump passages. Referring to FIG. 9, the solid line indicates a relationship between the pump efficiency η and the seal width a1. Fuel is discharged by the discharge amount Q1 after passing through the first pump passage 302, and fuel is discharged by the discharge amount Q2 after passing through the second pump passage 306. In FIG. 9, each of the dotted lines indicates a relationship between a value of Q2/Q1 and the seal width a1. The dotted lines indicate the relationships between the values of Q2/Q1 and the seal widths a1 for impellers 51 having the diameters of φ20, φ30, φ40, and φ50.

In this embodiment, the fuel pressure P1 of fuel after passing through the first pump passage 302 is also between 200 kPa and 800 kPa. The fuel pressure P2 of fuel after passing through the second pump passage 306 is equal to or less than 50 kPa. That is, the fuel pressure P1 is greater than the fuel pressure P2. In this structure, fuel leaks from the first pump passage 302 to the second pump passage 306, and hence, the pump efficiency η decreases. This leakage of fuel can be reduced by increasing the seal width a1. When the seal width a1 is equal to or greater than 1 mm, the pump efficiency η1 becomes equal to or greater than 40%, and sufficient pump efficiency η1 can be obtained. Alternatively, when the seal width a1 is less than 1 mm, fuel may leak from the first pump passage 302 to the second pump passage 306, and hence, the pump efficiency η1 drastically decreases. Alternatively, when the seal width a1 is equal to or greater than 2.5 mm, the pump efficiency η1 becomes substantially constant, and does not further increase.

In addition, when the seal width a1 is excessively large, the second cross sectional area S2 of the second pump passage 306 cannot be sufficiently secured, and the relationship of Q2≧Q1 cannot be satisfied. When a value of Q2/Q1 is equal to or greater than 1, the relationship of Q2≧Q1 is satisfied. To satisfy the relationship of Q2≧Q1, the seal width a1 is set to be equal to or less than 8.5 mm when the impeller 51 has the diameter of φ50, and the seal width al is set to be equal to or less than 2.5 mm when the impeller 51 has the diameter of φ30. The diameter of p30 is a general value. In view of these premises, an optimum range of the seal width a1 mm is defined by the following formula (13).

1≦a1≦2.5 (13)

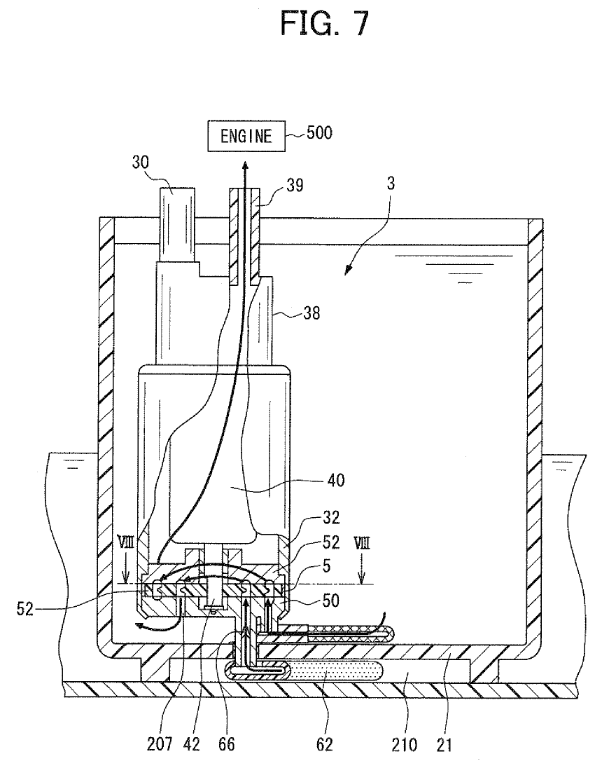

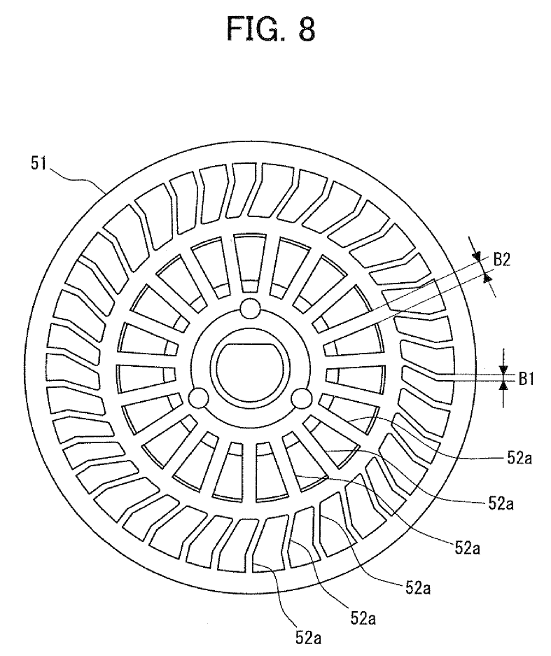

As shown in FIGS. 7, 8, in this embodiment, each vane plate defining vane grooves 52a on the radially outer side has a thickness B1, and each vane plate on the radially inner side has a thickness B2. The thickness B1 and the thickness B2 satisfy the relationship of B2≧B1.

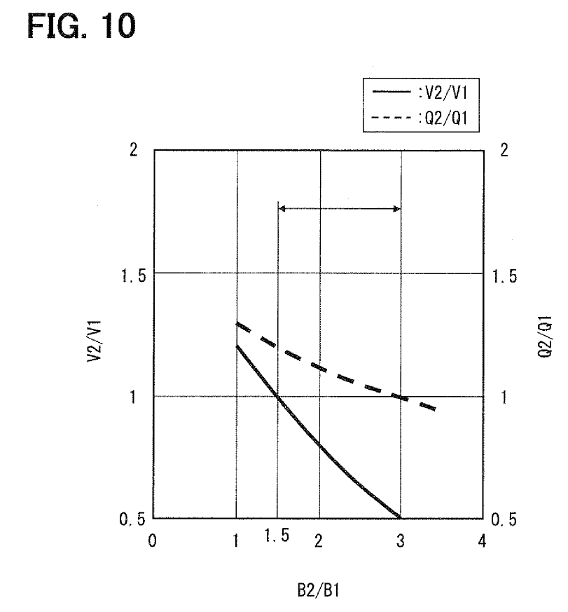

The vane plate of the impeller 51 on the radially inner side swells at swelling speed V2, and the vane plate of the impeller 51 on the radially outer side swells at swelling speed V1, when being in fuel. The swelling speed V2 and the swelling speed V1 have a swelling speed ratio V2/V1. As the surface area of the impeller 51 becomes large, the swelling speed of the vane plate of the impeller 51 becomes large, and the thickness of the vane plate becomes small. The thickness B1 of the vane grooves 52a on the radially outer side and the thickness B2 of the vane grooves 52a on the radially inner side have a thickness ratio B2/B1. In FIG. 10, the solid line indicates a relationship between the swelling speed ratio V2/V1 and the thickness ratio B2/B1. When the swelling speed ratio V2/V1 is equal to or greater than 1, that is, when the swelling speed V2 is equal to or greater than the swelling speed V1, the impeller 51 on the radially inner side needs a clearance greater than a clearance defined based on the impeller 51 on the radially outer side. Therefore, the swelling speed ratio V2/V1 is preferably equal to or less than 1, When the swelling speed ratio V2/V1 is equal to 1, the thickness ratio B2/B1 is 1.5.

In FIG. 10, the dotted line indicates a relationship between the value of Q2/Q1 and the thickness ratio B2/B1. When the value of the thickness B1, B2 of the vane plates is increased, the swelling speed becomes low, nevertheless, the second cross sectional area S2 of the second pump passage 306 in FIG. 6 cannot be sufficiently secured, and the relationship of Q2≧Q1 cannot be satisfied. The thickness ratio B2/B1 is equal to or less than 3 to satisfy the relationship of Q2≧Q1. Thus, the range of the thickness ratio B2/B1 satisfying the swelling speed and an amount of fuel in the pump chamber is defined by the following formula (14).

1.5≦(B2/B1)≦3 (14)

In this embodiment, the first pump passage and the second pump passage therebetween define a seal portion having a seal width a1, which satisfies: 1≦a1≦2.5. The seal width a1 is defined to be equal to or greater than 1 mm, and hence, fuel can be restricted from leaking from the first pump passage 302 to the second pump passage 306. Further, the amount Q2 of fuel supplied from the fuel tank 2 to the sub-tank 20 can be restricted from becoming excessively greater than the amount of fuel Q1 supplied from the sub-tank 20 to the engine 500, by defining the seal width a1 to be equal to or less than 2.5 mm. Thus, the pump efficiency η in the pump passage can be enhanced.

The impeller 51 has the first vane plates defining the first vane grooves and each having the thickness B1. The impeller 51 has the second vane plates defining the second vane grooves and each having the thickness B2. The B1 and B2 satisfy: 1.5≦B2/B1≦3. As the thickness of each vane plate becomes small, the swelling speed increases. However, as the thickness of each vane plate becomes large, the cross sectional area of the pump passage correspondingly becomes small, and consequently, the amount of fuel discharged from the fuel pump decreases. Therefore, the value of B2/B1 is set to be equal to or greater than 1.5, and the swelling speed of each second vane plate is set to be equal to or less than the swelling speed of each first vane plate. Thus, the clearance between the impeller 51 and the pump case can be maintained, so that the impeller 51 and the pump case can be restricted from being in contact with each other. In addition, the relationship of Q2≧Q1 can be satisfied by defining the value of B2/B1 to be equal to or less than 3. Thus, the pump efficiency η can be enhanced, and the level of the sub-tank 20 can be maintained.

One pump passage may be defined on one side of the impeller with respect to the rotation axis of the impeller.

In the first embodiment, the motor portion includes the brushless motor. Alternatively, the motor portion may include a motor with a brush.

The above structures of the embodiments can be combined as appropriate.

Various modifications and alternations may be diversely made to the above embodiments without departing from the spirit of the present invention.

What is claimed is:

1. A fuel pump for supplying fuel from a fuel tank to a sub-tank accommodated in the fuel tank and supplying fuel from the sub-tank to an engine, the fuel pump comprising:
an impeller having a plurality of first vane grooves and a plurality of second vane grooves each arranged along a rotative direction of the impeller, the plurality of second vane grooves being located on a radially inner side of the plurality of first vane grooves with respect to a radial direction of the impeller; and
a pump case rotatably accommodating the impeller and having a first pump passage and a second pump passage each being defined along the rotative direction, the first pump passage being defined along the first vane grooves for supplying fuel from the sub-tank to the engine, the second pump passage being defined along the second vane grooves for supplying fuel from the fuel tank to the sub-tank,
wherein the first and second pump passages respectively have cross sectional areas S1, S2,
the first and second pump passages respectively have diameters D1, D2 with respect to a direction of a rotation axis of the impeller, and
the cross sectional areas S1, S2 and the diameters D1, D2 satisfy:
0.6≦(S2×D2)/(S1×D1)≦0.95.

2. The fuel pump according to claim 1,
wherein the first pump passage is adapted to supplying fuel at pressure P, and
the pressure P satisfies: 200 kPa≦P≦800 kPa.

3. The fuel pump according to claim 1,
wherein the second pump passage has a depth H2 with respect to the direction of the rotation axis,
the impeller has a thickness t, and
the depth H2 and the thickness t satisfy: 0.2≦H2/t≦0.6.

4. The fuel pump according to claim 3,
wherein the first pump passage has a depth H1 with respect to the rotation axis, and
the depth H1 and t satisfy: 0.3≦H1/t≦0.6.

5. The fuel pump according to claim 1,
wherein the second pump passage has a width W2 with respect to a radial direction of the impeller,
the second pump passage has a depth H2 with respect to the rotation axis, and
the width W2 and the depth H2 satisfy: 1.9≦W2/H2≦2.5.

6. The fuel pump according to claim 5,
wherein the first pump passage has a width W1 with respect to the radial direction,
the first pump passage has a depth H1 with respect to the rotation axis, and
the width W1 and the depth H1 satisfy: 1.5≦W1/H1≦2.1.

7. The fuel pump according to claim 1,
wherein the first pump passage and the second pump passage therebetween define a seal portion having a seal width a1, and
the seal width a1 satisfies: 1≦a1≦2.5.

8. The fuel pump according to claim 1,
wherein the impeller has a plurality of first vane plates defining the plurality of first vane grooves and each having a thickness B1,
the impeller has a plurality of second vane plates defining the plurality of second vane grooves and each having a thickness B2, and
the thickness B1 and the thickness B2 satisfy: 1.5≦B2/B1≦3.

9. The fuel pump according to claim 1, further comprising:
a motor portion for driving and rotating the impeller.

10. A fuel feed apparatus comprising:
the fuel pump according to claim 1; and
the sub-tank accommodating the fuel pump and received in the fuel tank,
wherein the first pump passage has an inlet located inside of the sub-tank,
the first pump passage has an outlet for supplying fuel to the engine,
the second pump passage has an inlet located outside of the sub-tank and opening in the fuel tank, and
the second pump passage has an outlet opening in the sub-tank.

11. A fuel feed apparatus for supplying fuel from a fuel tank to an engine, the fuel feed apparatus comprising:
a sub-tank accommodated in the fuel tank; and
a fuel pump accommodated in the sub-tank for supplying fuel from the fuel tank to the sub-tank simultaneously with supplying fuel from the sub-tank to an engine,
wherein the fuel pump includes:
an impeller having a plurality of first vane grooves and a plurality of second vane grooves each arranged along a rotative direction of the impeller, the plurality of second vane grooves being located on a radially inner side of the plurality of first vane grooves; and
a pump case rotatably accommodating the impeller and having first and second pump passages each being defined along the rotative direction,
wherein the first pump passage extends along the first vane grooves,
the first pump passage communicates with an inlet, which is located inside of the sub-tank for drawing fuel, and communicates with an outlet for supplying fuel to the engine,
the second pump passage extends along the second vane grooves,
the second pump passage communicates with an inlet, which is located outside of the sub-tank and opening in the fuel tank for drawing fuel from the fuel tank, and communicates with an outlet opening in the sub-tank for supplying fuel to the sub-tank,
wherein the first and second pump passages respectively have cross sectional areas S1, S2,
the first and second pump passages respectively have diameters D1, D2 with respect to a direction of a rotation axis of the impeller, and
the cross sectional areas S1, S2 and the diameters D1, D2 satisfy:
0.6≦(S2×D2)/(S1×D1)≦0.95.
